(19) United States
(12) Patent Application Publication
(10) Pub. No.: US 2005/0025607 A1
(43) Pub. Date: Feb. 3, 2005

(54) Interlocking nut assembly to secure a bolt

(76) Inventor: Michael A. Guantonio, Monaca, PA (US)

Correspondence Address: James A. Hudak, Esq., Suite #304, 29425 Chagrin Blvd., Cleveland, OH, 44122, US

(21) Appl. No.: 10/630,136

(22) Filed: Jul. 31, 2003

(51) Int. Cl. F16B 37/08; F16B 39/12

(52) U.S. Cl. 411/222; 411/432

(57) ABSTRACT

An interlocking nut assembly to secure a bolt is disclosed. The interlocking nut assembly is comprised of two nuts, each nut being provided with internal threads having a number of threads per inch corresponding to the number of threads per inch provided on the bolt to be secured. The first nut is also provided with a concentric blind bore having female threads therein and the second nut is provided with the longitudinally extending concentric flange portion having male threads therein. The number of female threads per inch in the concentric blind bore in the first nut and the number of male threads per inch in the longitudinally extending concentric flange portion on the second nut are the same and are slightly less than the number of internal threads per inch in both nuts and the threads on the bolt to be secured. Since the number of female threads per inch in the concentric blind bore in the first nut and the number of male threads per inch in the longitudinally extending concentric flange portion on the second nut are slightly less than the number of internal threads per inch in both nuts and the threads on the bolt to be secured, a camming action is created between the internal threads on the nuts and the female threads in the first nut and the male threads on the second nut causing both nuts to engage the bolt to be secured and preventing the nuts from becoming loose on the bolt due to vibration, or the like.

### TECHNICAL FIELD

The present invention relates, in general, to a nut assembly to secure a bolt and, more particularly, to a unique interlocking nut assembly that secures a bolt and prevents the bolt from becoming loose due to vibration, or other conditions.

### BACKGROUND ART

Various approaches are available to secure a bolt in order to prevent the bolt from becoming loose due to vibration or other conditions. A common approach is to “double nut” the bolt. In this approach, two nuts are threadably advanced onto a bolt. The first nut is then tightened to secure the members to be held together and then the second nut is tightened against the first nut in order to secure same. Double nutting is not failsafe since, in many instances, the nuts can become loose, as a unit, on the bolt being secured. Other approaches include the use of a nylon insert within the nut causing the insert to be compressed into the threads on the bolt as the nut is threadably advanced thereon. Here again, this approach is not failsafe since the nut can become loose on the bolt and the nut usually cannot be reused since the nylon insert is deformed by the previous advancement of the nut on the bolt. Another approach is to utilize a lock washer between the member to be secured and the nut. Here again, this approach is not failsafe since the lock washer can become deformed due to compression allowing the bolt to become loose.

In view of the foregoing, it has become desirable to develop a relatively simple, inexpensive nut arrangement to secure a bolt.

### SUMMARY OF THE INVENTION

The present invention solves the problems associated with the prior art approaches of securing a bolt, and other problems, by providing an interlocking nut assembly comprising two nuts, each nut being provided with internal threads having a standard number of threads per inch corresponding to the standard number of threads per inch provided on the bolt to be secured. The first nut is also provided with a concentric blind bore having female threads therein while the second nut is provided with a longitudinally extending concentric flange portion having male threads therein. In the preferred embodiment of the present invention, the number of female threads per inch in the concentric blind bore in the first nut and the number of male threads per inch in the longitudinally extending concentric flange portion on the second nut are the same and are slightly less than the number of internal threads per inch in both nuts and the threads on the bolt to be secured. To secure the bolt, the first nut is threadably advanced thereon and then the second nut is similarly threadably advanced thereon causing the longitudinally extending concentric flange portion on the second nut to be received within concentric blind bore in the first nut resulting in the male threads in the longitudinally extending concentric flange portion on the second nut to threadingly engage the female threads in the concentric blind bore in the first nut. Since the number of female threads per inch in the concentric blind bore in the first nut and the number of male threads per inch in the longitudinally extending concentric flange portion on the second nut are the same and slightly less than the number of internal threads per inch in both nuts and on the bolt to be secured, a camming action is created between the internal threads on the nuts and the female threads on the first nut and the male threads on the second nut causing both nuts to securely engage the bolt and preventing the nuts from becoming loose on the bolt due to vibration, or other conditions.

### BRIEF DESCRIPTION OF THE DRAWINGS

FIG. 1 is a perspective view of a bolt showing the interlocking nut assembly of the present invention thereon.

FIG. 2 is a front elevational view of the interlocking nut assembly of the present invention installed on a bolt and illustrates the members to be secured and a portion of the bolt in cross-section.

FIG. 3 is an exploded front elevational view of a bolt to be secured and a cross-sectional view of the interlocking nut assembly of the present invention installed on the bolt.

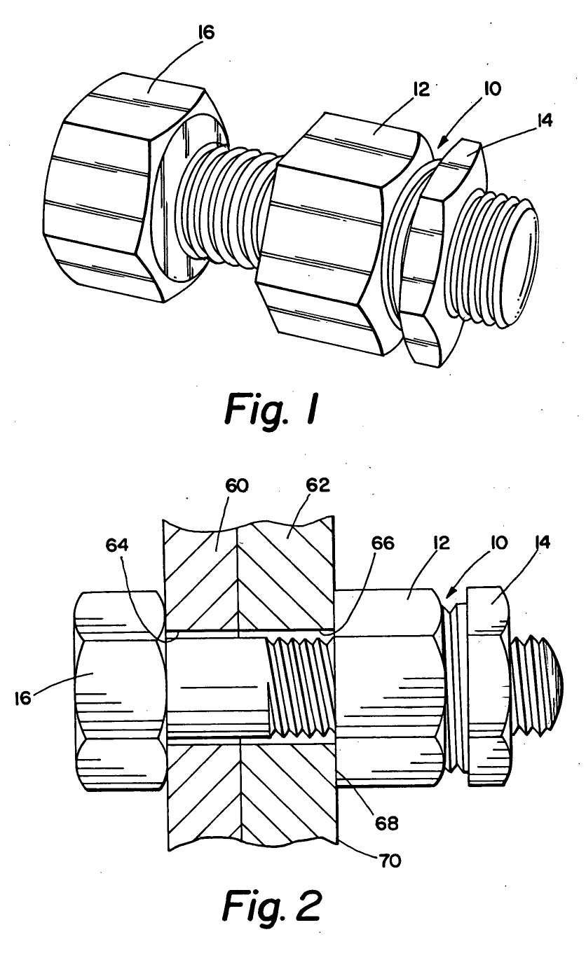

### DESCRIPTION OF THE PREFERRED EMBODIMENT

Referring now to the drawings where the illustrations are for the purpose of describing the preferred embodiment of the present invention and are not intended to limit the invention described herein, FIG. 3 is an exploded front elevational view of a bolt to be secured and is a cross-sectional view of the interlocking nut assembly 10 of the present invention to be installed on the bolt. The interlocking nut assembly 10 is comprised of nuts 12 and 14 which are threadably received on a bolt 16 having a standard number of threads per inch and are utilized to prevent the bolt 16 from loosening due to vibration or other conditions to which it may be subjected.

Nut 12 is typically formed from a metallic material and is provided with internal threads 18 having the same number of threads per inch as the threads on bolt 16. A concentric blind bore 20 is provided in end 22 of nut 12 and is comprised of a bottom surface 24, an outer wall 26 and female threads 28 in outer wall 26. A concentric chamfered surface 30 interconnects bottom surface 24 of concentric blind bore 20 with internal threads 18 in nut 12. The number of female threads 28 per inch is slightly less than the number of threads per inch utilized for internal threads 18 in nut 12.

Nut 14 is typically formed from metallic material, similar to the material utilized for nut 12, and is provided with internal threads 40 having the same number of threads per inch as threads 18 in nut 12 and the threads on bolt 16. Nut 14 includes a longitudinally extending concentric flange portion 42 defined by an inner concentric surface 44, an end surface 46 and an outer concentric surface 48 having male threads 50 therein. The number of male threads 50 per inch in outer concentric surface 48 is the same as the number of female threads 28 per inch in outer wall 26 defining concentric blind bore 20 in nut 12. Thus, the number of male threads 50 per inch is slightly less than the number of internal threads 40 per inch in nut 14 and the number of internal threads 18 per inch in nut 12. The diameter defined by inner concentric surface 44 of longitudinally extending flange portion 42 on nut 14 is slightly greater than the diameter of the threads on the bolt 16 to be secured. The diameter of outer concentric surface 48 defining longitudinally extending flange portion 42 on nut 14 is such so that male threads 50 therein can threadably engage female threads 28 in outer wall 26 defining concentric blind bore 20 in nut 12.

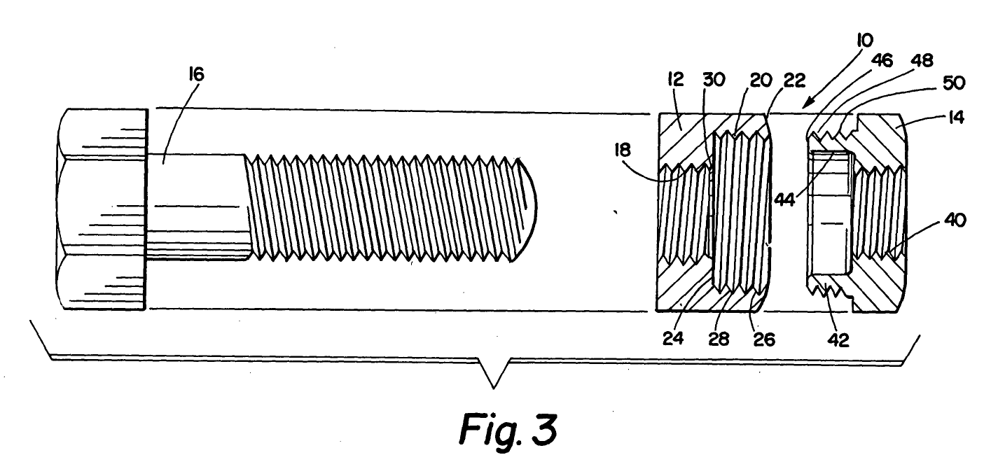

In practice, when the interlocking nut assembly 10 of the present invention is utilized to secure two members together, such as members 60, 62, as shown in FIG. 2, a standard bolt 16 is received through apertures 64, 66, in members 60, 62, respectively. Nuts 12 and 14 are then attached together by allowing two or three of the male threads 50 in outer concentric surface 48 defining longitudinally extending flange portion 42 on nut 14 to threadingly engage female threads 28 in outer wall 26 defining concentric blind bore 20 in nut 12. Nuts 12 and 14, whose respective internal threads 18 and 40 have the same number of threads per inch as the threads on standard bolt 16, are then threadably advanced on bolt 16 until surface 68 on nut 12 contacts surface 70 on member 62. Nut 12 is then tightened so that surface 68 thereon firmly engages surface 70 on member 62 causing members 60 and 62 to firmly contact and engage one another. Nut 14 is then tightened into nut 12. Since the number of internal threads 18, 40 per inch in nuts 12, 14, respectively, is slightly greater than both the number of male threads 50 per inch in outer concentric surface 48 defining longitudinally extending flange 42 on nut 14 and the number of female threads 28 per inch in outer wall 26 defining concentric blind bore 20 in nut 12, a camming action is created between the internal threads 18, 40, in nuts 12, 14, respectively, and the female threads 28 in nut 12 and the male threads 50 in nut 14 causing both nuts 12 and 14 to firmly engage bolt 16 preventing the nuts 12, 14, from becoming loose on bolt 16 as a result of vibration, or other conditions. For example, if bolt 16 has a standard thread of 12 threads per inch, the internal threads 18, 40, in nuts 12, 14, respectively, will also have 12 threads per inch resulting in an advancement of 0.0833 inch for each revolution of the nuts 12, 14. In this case, the female threads 28 in nut 12 and male threads 50 in outer concentric surface 48 defining longitudinally extending flange 42 on nut 14 will have 11.6 threads per inch resulting in an advancement of 0.08621 inch for each revolution of the nuts 12, 14. The difference in advancement of 0.003 inch for each revolution of the nuts 12, 14 causes the aforementioned camming action. Because of this camming action, the bolt 16 does not loosen after the nuts 12, 14, have been tightened on the bolt 16 to torque specifications. It should be noted that the aforementioned description is directed to threadably advancing the nuts 12, 14, as a unit on bolt 16. The same result can be achieved if nut 12 is threadably advanced on bolt 16 so that surface 68 thereon firmly engages surface 70 on member 62 causing members 60 and 62 to firmly contact and engage one another, and then nut 14 is threadably advanced on bolt 16 and tightened into nut 12. Alternatively, it should be also be noted that the number of internal threads 18, 40 per inch in nuts 12, 14, respectively, can be slightly greater than both the number of male threads 50 per inch in outer concentric surface 48 defining longitudinally extending flange 42 on nut 14 and the number of female threads 28 per inch in outer wall 26 defining concentric blind bore 20 in nut 12 to create the same camming action and the same interlocking effect of the nuts 12, 14 on bolt 16.

The actual lead and pitch of the internal threads 18, 40 in nuts 12, 14, respectively, versus the lead and pitch of the female threads 28 and male threads 50 in nuts 12, 14, respectively, may vary slightly depending upon the material utilized for the nuts. However, the actual differential in advancement per revolution of one nut relative to the other nut will be established by experimentation and calculation. Regardless of the differential in nut advancement per revolution, the locking concept involving the nuts on the bolt remains the same.

Certain modifications and improvements will occur to those skilled in the art upon reading the foregoing. It is understood that all such modifications and improvements have not been included herein for the sake of conciseness and readability, but are properly within the scope of the following claims.

1) An interlocking nut assembly to secure a bolt comprising a first nut having internal threads therein and having a blind bore with female threads provided therein, and a second bolt having internal threads therein and having a longitudinally extending flange portion with male threads therein, said internal threads in said first nut and in said second nut having a first number of threads per inch substantially corresponding to the number of threads per inch provided on the bolt to be secured, said female threads in said blind bore in said first nut and said male threads in said longitudinally extending flange portion on said second nut having a second number of threads per inch, said second number of threads per inch differing from said first number of threads per inch.

2) The interlocking nut assembly as defined in claim 1 wherein said blind bore in said first nut and said longitudinally extending flange portion on said second nut are concentrically aligned permitting said male threads in said longitudinally extending portion on said second nut to threadingly engage said female threads in said blind bore in said first nut.

3) The interlocking nut assembly as defined in claim 1 wherein said second number of threads per inch for said female threads in said first nut and for said male threads in said second nut are less than said first number of threads per inch for said internal threads in said first and second nuts.

4) The interlocking nut assembly as defined in claim 1 wherein said second number of threads per inch for said female threads in said first nut and for said male threads in said second nut are greater than said first number of threads per inch for said internal threads in said first and second nuts.
